(19) United States
(12) Patent Application Publication
(10) Pub. No.: US 2011/0019519 A1
(43) Pub. Date: Jan. 27, 2011

(54) OPTICAL DISC RECORDING METHOD AND OPTICAL DISC APPARATUS

(75) Inventor: Jeong Gyu PARK, Seoul (KR)

Correspondence Address: BIRCH STEWART KOLASCH & BIRCH, PO BOX 747, FALLS CHURCH, VA, 22040-0747, US

(73) Assignee: HITACHI-LG DATA STORAGE KOREA, INC., Seoul (KR)

(21) Appl. No.: 12/843,369

(22) Filed: Jul. 26, 2010

(30) Foreign Application Priority Data
Jul. 27, 2009 (KR) 10-2009-0068428

(51) Int. Cl. G11B 27/36

(52) U.S. Cl. 369/53.28; G9B/27.052

(57) ABSTRACT

This document relates to a method of compensating for a sensitivity variation of a tracking actuator with focusing offset when recording labels on a disc for label recording. A focusing point suitable for the position of an object lens in the circumference direction and/or the radius direction is detected, a tracking sensitivity corresponding to the detected focusing point is obtained based on information about a tracking sensitivity variation according to a focusing point variation, and labels are recorded on a label plane using the detected focusing point and tracking sensitivity. The information may be measured using at least two different types of discs one of which has a distance, between the surface of the disc and a pattern area required for a feed forward servo operation, different from the distance of the other.

This application claims the benefit of Korean Patent Application No. 10-2009-0068428 filed on Jul. 29, 2009, which is hereby incorporated by reference.

### BACKGROUND

1. Field

This document relates to an optical disc recording method and, more particularly, to a method of compensating for a sensitivity variation of a tracking actuator with focusing offset when recording labels on a disc for label recording.

2. Related Art

An optical disc apparatus and discs for label recording, such as LightScribe discs, enabling label printing on a plane opposite to the data plane on which data are recorded, are being popularized. The plane on which labels are recorded, of a disc for label recording, is called a label plane.

In the data plane of an optical disc, a recording layer in which marks are formed is formed in a disc for recording, pits are formed in a disc for playback and an additional reflection layer is formed. When an optical pickup radiates a laser beam on the data plane, the radiated laser beam is reflected from the reflection layer and is then incident on separated cells of a photo detector (PD) of the optical pickup. A focusing error signal and a tracking error signal can be generated based on signals outputted from the separated cells of the PD.

When performing a disc playback operation or a disc recording operation requested by a user, an optical disc apparatus performs a focusing servo operation for moving the object lens of the optical pickup in the up and down directions and a tracking servo operation for moving the object lens in the inner and outer circumference directions such that focusing error signals and tracking error signals generated based on signals reflected from the data plane of the optical disc can be minimized. A method of receiving a feedback error signal and performing a servo operation in response to the feedback error signal as described above is called servo of a feedback method.

However, since the label plane of the LightScribe disc does not have the reflection layer and has a very rough plane as compared with the data plane, the error signals enabling the focusing servo of a feedback method are not generated from the label plane. Accordingly, the focusing servo of a feedback method cannot be performed for the LightScribe disc, and the focusing servo of a feed forward method is inevitably performed for the LightScribe disc.

Lands and grooves are formed in the data plane of an optical disc for recording during the data recording process, and ATIP information for detecting the current position is also recorded on the data plane in a wobbled land and groove shape. Accordingly, the optical disc recording apparatus can perform the tracking servo operation of a feedback method based on push-pull signals generated from the lands and grooves, check the current position based on the ATIP information recorded on the data plane, and randomly access a desired position.

However, since the wobbled lands and grooves for the tracking servo and the random access are not formed in the label plane of a disc for label recording, the optical disc recording apparatus cannot perform the tracking servo operation of a feedback method based on the error signals, such as the push-pull signals, and also cannot randomly access a desired position. Accordingly, labels are indispensably sequentially recorded on a disc from the inner circumference to the outer circumference of the disc only in the feed forward method.

The movement from the inner circumference to the outer circumference of the object lens depends on the transfer of a sled motor and the movement of a tracking actuator. It is therefore inevitable that label printing on the label plane is sensitive to the dynamic characteristics of the sled motor and the tracking actuator of the optical pickup in relation to tracking servo.

The sensitivity of the tracking actuator of the optical pickup varies with focusing offset (focusing point), in general. Furthermore, the optical disc apparatus inevitably has a mechanical component that changes the focusing position of the object lens, such as disc warpage, radial skew, shaking of a turntable for fixing discs, etc.

This mechanical component that changes the characteristic and focusing position of the optical pickup during a process of recording labels on the label plane of a disc brings about tracking banding as shown in FIG. 1, that is, generation of a blank on which a label is not printed or repeated printing. FIG. 1 shows tracking banding generated in the outer circumference of a disc according to radial skew and disc warpage. It can be seen that the tracking banding is generated in the outer circumference of the disc rather than in the inner circumference of the disc because the outer circumference has disc warpage or radial skew larger than that of the inner circumference.

### SUMMARY

An aspect of this document is to provide a method of improving the label printing quality of a disc for label recording.

Another aspect of this document is to provide a method of compensating for a sensitivity variation of a tracking actuator with focusing offset when printing labels on a disc for label recording.

An optical disc recording method according to an embodiment of this document comprises detecting a focusing point suitable for a position of an object lens in a circumference direction and/or a radius direction; obtaining a tracking sensitivity corresponding to the detected focusing point based on information about a tracking sensitivity variation according to a focusing point variation; and recording labels on a label plane using the detected focusing point and tracking sensitivity.

An optical disc recording apparatus according to another embodiment of this document comprises an optical pickup configured to read data from a data plane of an optical disc and record data on the data plane or a label plane of the optical disc; a spindle motor configured to rotate the optical disc; a sled motor configured to move the optical pickup to the inner and outer circumferences; a detector configured to detect a position of the optical disc in a circumference direction; and a controller configured to control at least one of the optical pickup, the spindle motor, the sled motor, and the detector to detect a focusing point suitable for a position of an object lens in the circumference direction and/or a radius direction, obtains a tracking sensitivity corresponding to the detected focusing point based on information about a tracking sensitivity variation according to a focusing point variation and record labels on the label plane using the detected focusing point and tracking sensitivity.

In an embodiment, the information may be measured using at least two different types of discs one of which has a distance, between the surface of the disc and a pattern area, different from the distance of the other, the pattern area being required for a feed forward servo operation. The tracking sensitivity may be detected using a saw-teeth pattern included in the pattern area.

In an embodiment, the information may be measured during a process of manufacturing an optical disc apparatus or while a user uses the optical disc apparatus and stored in the optical disc apparatus.

In an embodiment, when a disc is divided into a predetermined number of areas in the circumference direction, the focusing point may be detected for each of the areas and applied to a focusing servo operation performed on the corresponding area. The position in the circumference direction may be checked by detecting spokes and an index mark included in the pattern area required for the feed forward servo operation.

In an embodiment, when a disc is divided into a predetermined number of sections in the radius direction, the focusing point may be detected for each of the sections and applied to a focusing servo operation performed on the corresponding section. The position of the object lens in the radius direction may be tracked based on a number of steps applied to a sled motor for moving an optical pickup including the object lens and a control value applied to a tracking actuator for moving the object lens in the inner and outer circumference directions.

Accordingly, the quality of recording on the label plane of an optical disc can be improved by simply correcting firmware without requiring an additional element or cost.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 shows banding generated in the outer circumference of a LightScribe disc;

FIG. 2 is a layout diagram of the label plane of a LightScribe disc;

FIG. 3 shows media ID fields, an index mark, and Saw-teeth areas which are included in the Control Feature Zone of the LightScribe disc;

FIG. 4 shows the Saw-teeth area and spokes;

FIG. 5 shows an example of obtaining the sensitivity of a tracking actuator from the Saw-teeth area;

FIG. 6 shows the cross-sections of a LightScribe CD and a LightScribe DVD;

FIG. 7 shows an example of obtaining a variation in the sensitivity of the tracking actuator with the focusing point of an object lens;

FIG. 8 shows an example in which the focusing point of the object lens is changed on a disc having radial skew;

FIG. 9 is a diagram showing an embodiment referring to the construction of an optical disc apparatus to which this document is applied; and

FIG. 10 is a flowchart illustrating an optical disk recording method according to an embodiment of this document.

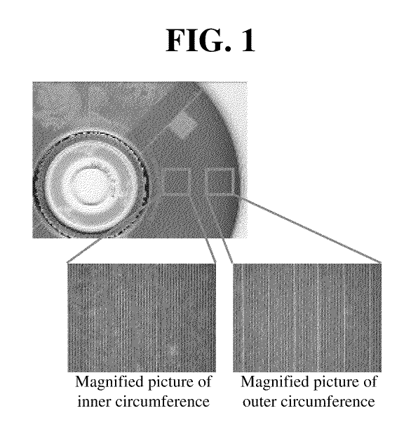

### DETAILED DESCRIPTION

Hereinafter, an optical disc recording method and an optical disc apparatus according to embodiments of this document will be described in detail with reference to the attached drawings.

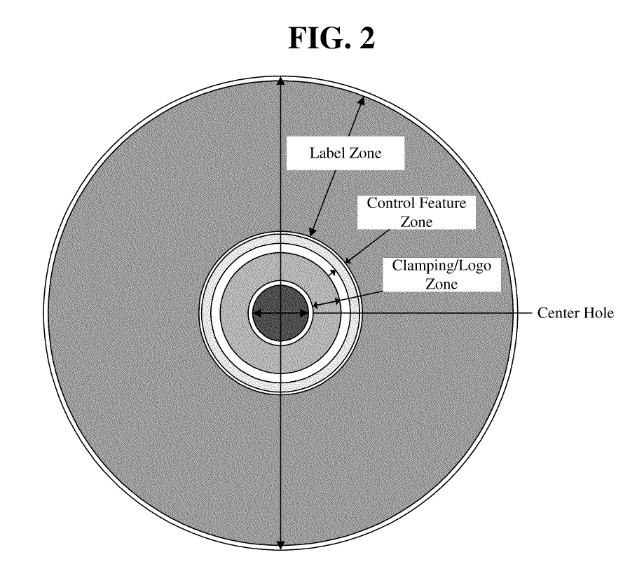

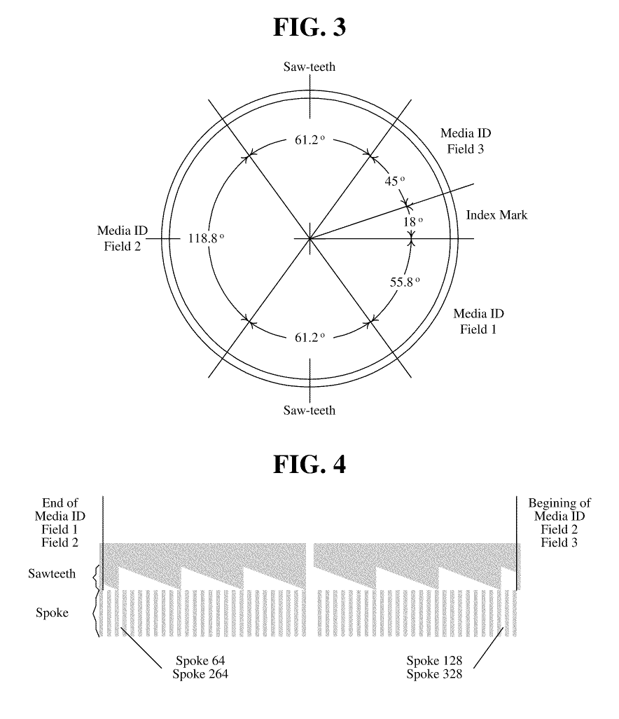

The layout of a label plane of a LightScribe recording disc is shown in FIG. 2. As shown in FIG. 3, the LightScribe disc has a Control Feature Zone including patterns for performing servo in the feed forward method. An index mark area, media ID areas (Media ID Field 1, 2, 3) such as media IDs, and saw-teeth areas are assigned to the Control Feature Zone. The media IDs are classified into discontinuous 3 fields, and the saw-teeth areas are separated from each other with the media ID fields interposed therebetween.

FIG. 4 shows the saw-teeth area and spokes. The saw-teeth area of 650 μm in width is separated into two areas facing each other by taking the eccentricity of the disc into consideration. The index mark is used to synchronize spoke 0. The spoke 0 is started at the end position of the index mark. The spoke 0 is a reference position in the circumference direction of the disc. 400 spokes exist in the disc. When the disc is rotated once, the current position in the circumference can be checked by detecting the index mark and the spokes.

In the saw-teeth area, portions having a high reflectance and portions having a low reflectance are engaged with each other in a triangle sawtooth form. When the disc is rotated with a laser beam placed at the center of the saw-teeth area, the duty ratio of a reflected signal becomes 50%. However, in the case where an object lens is made biased in the inner circumference direction or the outer circumference direction by applying a predetermined voltage to a tracking actuator (i.e., when the disc is rotated in the state in which the laser beam is biased from the center of the saw-teeth area to the inner circumference direction or the outer circumference direction), the duty ratio of a reflected signal becomes less than or more than 50%.

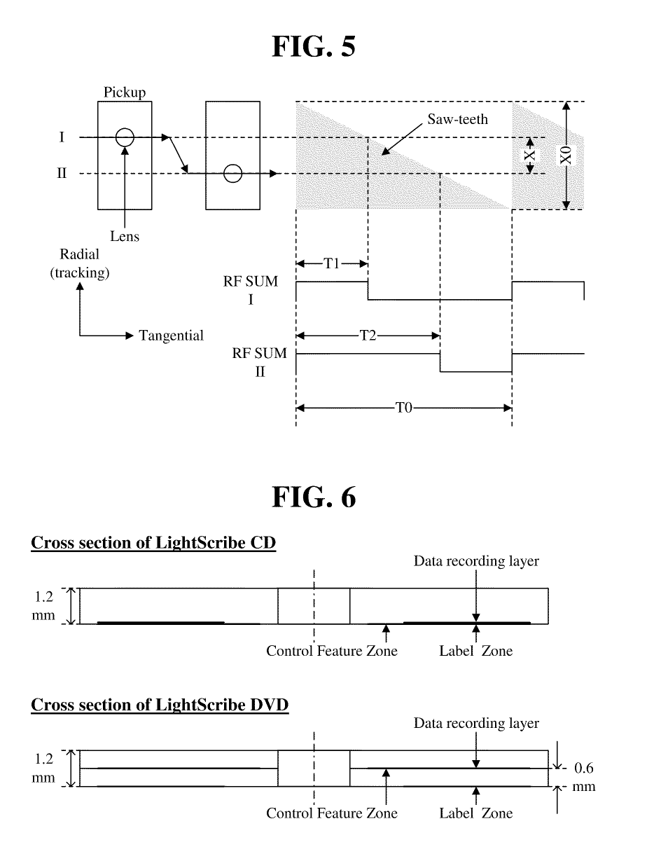

To perform tracking servo of a feed forward method, the actual sensitivity of the tracking actuator has to be measured. FIG. 5 shows an example of obtaining the sensitivity of the tracking actuator from the saw-teeth area of a disc.

While the disc is rotated at a predetermine velocity with an optical pickup moved to a position at which the saw-teeth area can be detected, the object lens is located at position I and a time interval T1 in which a signal RF SUM I reflected from a single saw-tooth of the rotating disc is detected is measured. Subsequently, a predetermined voltage V is applied to the tracking actuator to move the object lens to position II, and then a time interval T2 in which a signal RF SUM II reflected from a single saw-tooth of the rotating disc is detected is measured. Furthermore, a time interval T0 in which the signal RF SUM I or the signal RF SUM II is detected is measured. The width X0 of the inner and outer circumferences of the saw-teeth is 0.65 mm, and thus the distance X between positions I and II corresponds to X0×(T2−T1)/T0. Accordingly, the sensitivity of the tracking actuator can be obtained as G=X/|V|.

Accordingly, an optical disc apparatus enabling label recording measures the actual sensitivity of the tracking actuator (i.e., the amount of voltage that should be applied to the tracking actuator to move the object lens to the outer circumference by a predetermined distance) using the above method and performs the tracking servo of a feed forward method based on a result of measuring the actual sensitivity.

A feed forward tracking servo through the movement of the actuator for supporting the object lens in the outer circumference direction and the movement of a sled motor is briefly described below.

To sequentially print labels on an optical disc from the inner circumference to the outer circumference of the label zone of the optical disc, the optical disc apparatus, on a large scale, moves the entire optical pickup to the outer circumference by a predetermined distance using the sled motor and, on a small scale, slowly moves the actuator for supporting the object lens to the outer circumference with the optical pickup being fixed.

With the object lens moved from the center of the optical pickup to the inner circumference direction or the outer circumference direction, the optical and electrical performances of the optical pickup are deteriorated. Accordingly, when the object lens is deviated from the center of the optical pickup in the outer circumference direction by a predetermined distance or more, the sled motor operates to move the entire optical pickup in the outer circumference direction. While the entire optical pickup is moved, the object lens placed in the outer circumference of the optical pickup has to be moved to the center of the optical pickup or the inner circumference of the optical pickup.

For example, assuming that the optical performance is greatly deteriorated when the object lens is biased toward the inner or outer circumference by 100 μm from the center of the optical pickup, the entire optical pickup has to be moved when the object lens is moved toward the inner or outer circumference by a value less than 100 μm (for example, 75 μm). In this case, a minimum unit in which the sled motor can move the optical pickup can be determined as 150 μm (i.e., two times the 75 μm). That is, if the object lens is moved in the outer circumference direction by 75 μm, the sled motor has to move the entire optical pickup by 150 μm in the outer circumference direction and, at the same time, the actuator has to operate to drive the object lens in the inner circumference direction by a 150 μm-track pitch (i.e., a 75 μm-track pitch from the center of the optical pickup) about the current position of the object lens in the optical pickup. In other words, if the actuator is moved in the outer circumference direction by a predetermined distance, the entire optical pickup has to move to the outer circumference by a minimum unit and, at the same time, the actuator has to move in the inner circumference direction. Considering this operation in terms of the disc, the object lens is not moved while the optical pickup is moved to the outer circumference.

Labels can be recorded on the disc using a method of recording the labels on the disc in a concentric circle while rotating the disc once at the current position of the object lens, moving the object lens to the outer circumference by a predetermined distance using the tracking actuator, and then rotating the disc once at the moved position. Alternatively, labels can be spirally recorded on the disc using a method of slowly moving the object lens to the outer circumference by driving the tracking actuator while the disc is rotated.

As described above, since focusing error signals are not generated from the label plane of the LightScribe disc, a focusing servo of a feed forward method is inevitably performed for the LightScribe disc and a plane vibrating component existing on the disc cannot be compensated in the feed forward method.

The optical recording apparatus may divide an optical disc into a predetermined number of areas, for example, 20 areas Areas 0 through 19, in the circumference direction of the disc, detect most suitable focus points with respect to the respective areas, store the detected focus points and perform the focusing servo of a feed forward method based on the most suitable focus points.

Furthermore, the optical recording apparatus may divide the label plane of the optical disc into a predetermined number of sections (for example, sections each corresponding to 32 tracks) in the radius direction of the label plane of the optical disc and perform the above operation on the respective sections. Specifically, the optical recording apparatus may divide the label plane into a predetermined number of areas in the circumference direction of the optical disc, detect most suitable focus points with respect to the respective areas and perform the focusing servo by using the most suitable focus points.

In the case of a DVD, the disc is less warped since a substrate of 0.6 mm in thickness is bonded to both sides of a recording layer and the standard for the DVD is strict. In the case of a CD, the disc is easily warped or unbalanced because the standard is not strict and discs are mass-produced at low cost, and thus the object lens is moved in the focusing direction many times in order to track plane vibration and waving during a recording operation performed on the label plane. This phenomenon causes lots of banding in label printing on a LightScribe CD.

FIG. 6 shows the cross-sections of a LightScribe CD and a LightScribe DVD. The Control Feature Zone of the LightScribe CD is located in the recording layer placed apart from the data plane by 1.2 mm, and thus the Control Feature Zone is placed on almost the surface of the label plane. The Control Feature Zone of the LightScribe CD is located in the recording layer placed apart from the data plane by 0.6 mm, and thus the Control Feature Zone is placed apart from about 0.6 mm from the label plane. That is, the Control Feature Zones of the LightScribe CD and the LightScribe DVD exist at different positions from the label plane.

Accordingly, sensitivities of the tracking actuator at two different focusing points can be measured using the structural difference between the LightScribe DVD and the LightScribe CD that the Control Feature Zones of the LightScribe DVD and the LightScribe CD are located at different positions.

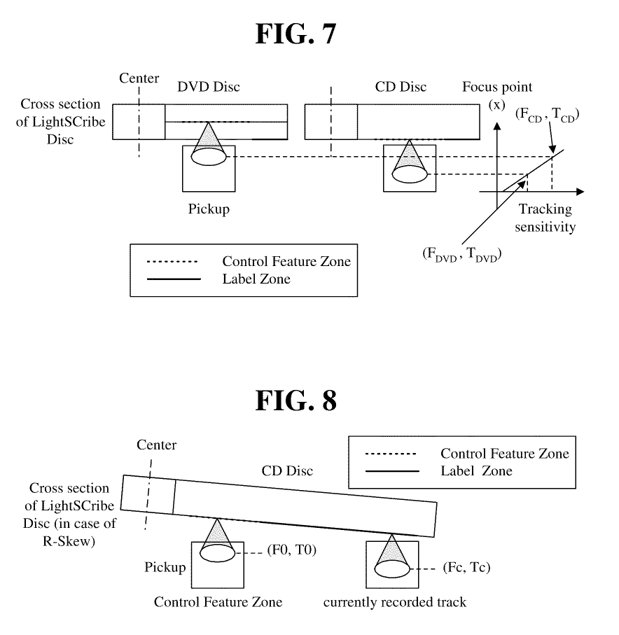

As shown in FIG. 7, a focusing point F_{DVD} and a sensitivity T_{DVD} of the tracking actuator are measured in the Control Feature Zone of the LightScribe DVD and a focusing point F_{CD} and a sensitivity T_{CD} of the tracking actuator are measured in the Control Feature Zone of the LightScribe CD. The sensitivities of the tracking actuator can be measured using the method shown in FIG. 5.

A simple equation that passes points (F_{DVD}, T_{DVD}) and (F_{CD}, T_{CD}) in the coordinates can be obtained as follows.

$$\begin{matrix}y = ( {T}_{DVD} - {T}_{CD} ) / ( {F}_{DVD} - {F}_{CD} ) x + \\ ( {F}_{DVD \times } {T}_{CD} - {F}_{CD} \times {T}_{DVD} ) / ( {F}_{DVD} - {F}_{CD} ) \\ = a x + b\end{matrix}$$

where x represents the focusing point, y denotes the sensitivity of the tracking actuator, a=(T_{DVD}−T_{CD})/(F_{DVD}−F_{CD}), and b=(F_{DVD×}T_{CD}−F_{CD}×T_{DVD})/(F_{DVD}−F_{CD})

In this equation, a slope a represents a sensitivity variation of the tracking actuator with a variation in the focusing point. Accordingly, it is possible to correct the sensitivity of the tracking actuator according to focusing offset during label recording by using the slope a.

The sensitivity of the tracking actuator according to focusing offset during label recording may be compensated using a linear equation y=−ax(x−F₀)+T₀ that has a slope −a and passes a point (F₀, T₀) in the coordinates. Here, F₀ represents focusing offset with respect to the disc surface, measured in the Control Feature Zone and T₀ represents the sensitivity of the tracking actuator, measured in the Control Feature Zone). An output voltage of the tracking actuator having the compensated sensitivity may be obtained using the following calculating method.

As shown in FIG. 8, if focusing offset at the current position is Fc, the sensitivity Tc of the tracking actuator at the current position can be calculated as Tc=−ax(F_{C}−F₀)+T₀ and the ratio R of the sensitivity of the tracking actuator at the current position to the sensitivity of the tracking actuator in the Control Feature Zone can be calculated as R=T_{C}/T₀.

If a tracking actuator driving voltage required to move the object lens in the outer circumference direction by a predetermined distance when the focusing offset is F₀ is V₀, a tracking actuator driving voltage V_{C} required to move the object lens in the inner or outer circumference direction by a predetermined distance when the focusing offset is F_{C} can be obtained as follows. F_{C} is changed during label recording and F₀, T₀, and a are fixed values.

$$\begin{matrix}{V}_{C} = {V}_{0} \times R \\ = {V}_{0} \times {T}_{C} / {T}_{0} \\ = {V}_{0} - {V}_{0} \times ( {F}_{C} - {F}_{0} ) \times a \\ = {V}_{0} - {V}_{0} \times ( {T}_{DVD} - {T}_{CD} ) / ( {F}_{DVD} - {F}_{CD} )\end{matrix}$$

The driving voltage obtained as above may be applied to the tracking actuator to record labels on the label plane of the disc with the object lens being moved to the inner or outer circumference. As described above, the most suitable focusing point F_{C} in each of areas divided in the circumference direction and the radius direction is measured and applied when performing a focusing servo in the feed forward method. Accordingly, the tracking actuator can be driven to move the object lens to the inner or outer circumference by driving a focusing actuator such that the object lens is located at the focusing point most suitable for the current recording position (position in the circumference direction and position in the radial direction) and compensating for the sensitivity of the tracking actuator such that the sensitivity corresponds to the focusing point.

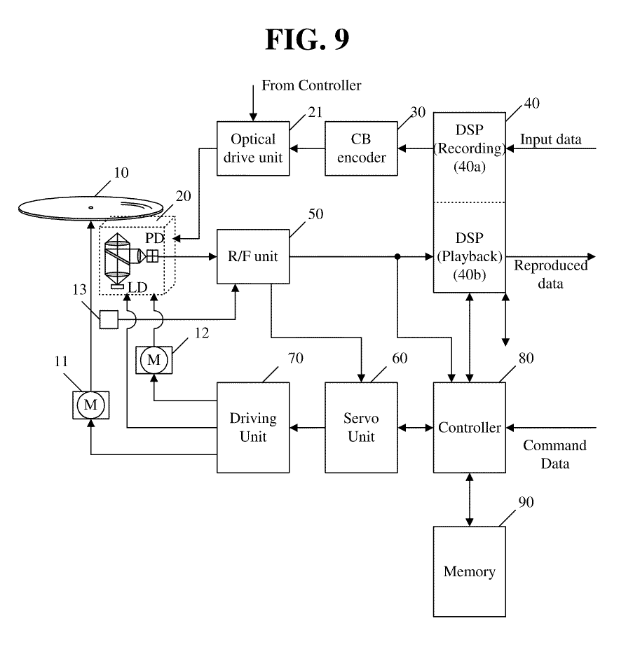

An optical disc recording method according to an embodiment of this document can be applied to a disc recording apparatus capable of recording labels on a disc for label recording. FIG. 9 is a diagram showing an embodiment referring to the construction of an optical disc apparatus to which this document is applied.

The optical disc apparatus may comprise a spindle motor 11, a sled motor 12, a spoke detector 13, and an optical pickup 20 which records data on an optical disc or reads data from the optical disc using a laser beam, a recording/playback unit which drives the spindle motor 11, the sled motor 12, and the optical pickup 20 and processes servo signals and recording/playback data, a controller 80 for controlling the recording/playback unit, and a memory 90. The recording/playback unit may comprise an optical drive unit 21, a channel bit encoder 30, a digital recording signal processor 40a, a digital playback signal processor 40b, an R/F unit 50, a servo unit 60, and a drive unit 70, and so on. The optical drive unit 21 may be included in the optical pickup 200.

The digital recording signal processor 40a adds error correction codes (ECC), etc. to received digital data and converts a format of the digital data into a recording format. The channel bit encoder 30 converts the data having the recording format into bit streams. The optical drive unit 21 outputs a laser-intensity driving signal according to a received signal. The optical pickup 20 records the data onto an optical disc 10 in response to the laser-intensity driving signal and reads data from a data plane of the optical disc 10.

The R/F unit 50 filters and normalizes a signal detected by the optical pickup 20 and outputs a binary signal. The R/F unit 50 further generates a tracking error signal TE, a focus error signal FE, a RF signal, etc. The digital playback signal processor 40b restores the binary signal to its original data using a clock signal whose phase has been synchronized with the binary signal. The servo unit 60 generates servo signals for a focusing servo operation, a tracking servo operation, a sled servo operation, and a spindle servo operation in response to the signal generated by the R/F unit 50. The drive unit 70 drives the spindle motor 11 for rotating the optical disc 10, drives the sled motor 12 for moving the optical pickup 20 in the inner or outer circumference direction, and also drives current for the focusing servo operation and the tracking servo operation for an object lens within the optical pickup 20.

The controller 80 controls the elements of the optical disc apparatus such that data are recorded onto the optical disc or data recorded onto the optical disc are read. The controller 80 controls the optical drive unit 21 such that a laser diode within the optical pickup 20 is driven as power for playback in order to read data from the optical disc 10 or the laser diode is driven as power for recording in order to record data on the optical disc 10.

Further, the controller 80 controls the servo unit 60 and the drive unit 70 based on the RF signal and the servo signals, detected by the optical pickup 20 and outputted from the R/F unit 50, such that the spindle motor 11 operates to rotate the optical disc 10 at a desired velocity and the sled motor 12 operates to move the optical pickup 20 to a desired position. The controller 80 controls the drive unit 70 to apply current to the actuator that supports the object lens within the optical pickup 20 and performs the focusing servo operation and the tracking servo operation.

When recording labels on the label plane, the digital recording signal processor 40a converts data for label recording into a format for label recording. The channel bit encoder 30 can bypass the converted label data. The controller 80 controls the servo unit 60 and the drive unit 70 such that the focusing servo operation is performed in the feed forward method, and the rotation of the disc, the transfer of the optical pickup 20, and the movement of the tracking actuator are also controlled in the feed forward method.

The spoke detector 13 detects an index mark and spokes from the Control Feature zone of a rotating LightScribe disc. The controller 80 may confirm whether a disc inserted into the optical disc apparatus is a LightScribe disc based on a signal detected by the spoke detector 13, control a rotating velocity of the disc and check the number of spokes detected after the index mark is detected to confirm the current position in the circumference direction. For reference, the current position of the object lens in the radius direction can be tracked based on the number of steps applied to the sled motor 12 and a driving voltage applied to the tracking actuator of the optical pickup 20.

In the case of a LightScribe DVD, the controller detects a most suitable focusing point F_{DVD} in the Control Feature Zone located apart from the label plane by about 0.6 mm and a sensitivity T_{DVD} of the tracking actuator using the method described above with reference to FIG. 5 and stores the detected focusing point F_{DVD} and sensitivity T_{DVD} in the memory 90. In the case of a LightScribe CD, the controller 80 detects a most suitable focusing point F_{CD} in the Control Feature Zone located on the label plane and a sensitivity T_{CD} of the tracking actuator and stores the detected focusing point F_{CD} and sensitivity T_{CD} in the memory 90. This operation may be performed during a process of manufacturing the optical disc apparatus. Otherwise, the operation may be carried out intermittently or whenever label recording on a disc is requested while a user uses the optical disc apparatus so as to reflect a variation in the performance of the actuator with the lapse of time.

The controller 80 may obtain the slope a=(T_{DVD}−T_{CD})/(F_{DVD}−F_{CD}) that represents a variation in the sensitivity of the tracking actuator with a focusing point variation based on the values detected as above and store the slope a in the memory 90.

When a LightScribe disc is inserted into a disc tray with the label plane of the LightScribe disc facing the object lens, the controller 80 detects a most suitable focusing point F₀ in the Control Feature Zone and a sensitivity T₀ of the tracking actuator and stores the detected focusing point F₀ and sensitivity T₀ in the memory 70 such that the stored values can be used to compensate for the sensitivity of the tracking actuator according to a focusing point when labels are recorded on the disc.

The controller 80 controls the servo unit 60 and the driver unit 70 to obtain a most suitable focusing point at each position in the circumference direction. Specifically, the optical disc 10 is divided into a predetermined number of areas in the circumference direction, for example, 20 areas Areas 0 through 19. The controller 80 detects an RF signal while controlling the spindle motor 11 to rotate the optical disc 10, controlling the sled motor 12 to drive the optical pickup 20 to access a specific position in the inner circumference of the label plane, and performing a focus swing operation that moves the object lens included in the optical pickup 20 in the up and down directions at least once for each of the 20 areas. The controller 80 may detect the positions of the object lens at which the RF signal has the largest amplitude (more specifically, a voltage or a focusing control value applied to the focusing actuator in order to locate the object lens at the position) as a most suitable focusing point for each area and store the detected focusing points in the memory 90. When the label plane is divided in the circumference direction, the first area may be started at the end position of the index mark, which is a reference position of the LightScribe disc, that is, spoke 0.

When the controller 80 has performed a feed forward focusing servo operation using the detected most suitable focusing points in the respective areas in the circumference direction and carried out label recording on a predetermined portion of the disc, that is, when the controller 80 has performed a label recording operation on a predetermined number of tracks (for example, 32 tracks), the controller 80 may temporarily stop the label recording operation and repeat the operation of detecting most suitable focusing points with respect to the predetermined number of areas (20 areas) at the stopped point and storing the detected focusing points as a focusing control value.

When the controller 80 moves the object lens to the inner or outer circumference for label recording while performing the focusing servo operation in the feed forward method using the most suitable focusing points with respect to the respective areas in the circumference direction, the controller 80 may obtain a driving voltage of the tracking actuator or a control value V_{C} with respect to the focusing point F_{C} that is the most suitable for the current position (a position in the circumference direction and a position in the radium direction) of the object lens through V_{C}=V₀×R=V₀×T_{C}/T₀=V₀−V₀×(F_{C}−F₀)×a, as described above with reference to FIG. 8, and perform the label recording operation while moving the object lens in the inner or outer circumference direction by a predetermined distance.

When a most suitable focusing point is obtained in order to perform the focusing servo operation in the feed forward method, the most suitable focusing point can be obtained by taking both the position of the object lens in the circumferential direction and the position of the object lens in the radius direction into consideration. However, the most suitable focusing point can also be obtained by taking only the position of the object lens in the radius direction, that is, by tracking a disc height varied according to the transfer of the object lens to the outer circumference. Otherwise, the most suitable focusing point can be obtained by taking only the position of the object lens in the circumference direction, that is, by tracking the disc height varied when the object lens is rotated.

Accordingly, it is possible to reduce banding generated due to a focusing point change caused by pickup characteristic, plane vibration, warpage, unbalance, etc. of discs and a variation in the sensitivity of the tracking actuator, particularly, frequently generated in the outer circumference of a LightScribe CD by performing label recording while compensating for the variation in the sensitivity of the tracking actuator with a change in the focusing point of each position (position in the circumference direction and/or position in the radius direction).

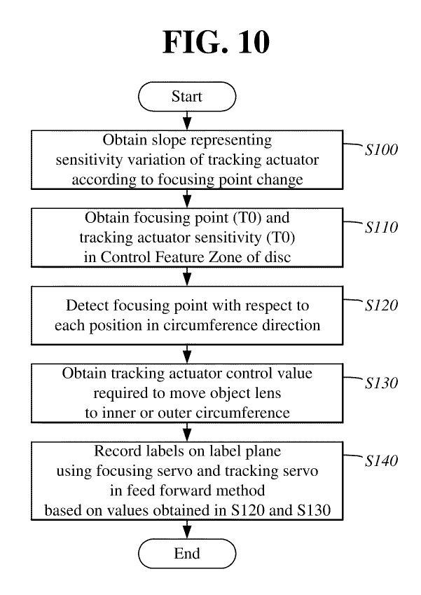

FIG. 10 is a flowchart illustrating an optical disk recording method according to an embodiment of this document.

The controller 80 of the optical disc apparatus obtains the slope a that represents a variation in the sensitivity of the tracking actuator according to a focusing point variation and stores the slope a in the memory 90 in operation 5100. The controller 80 may respectively detect most suitable focusing points F_{DVD} and F_{CD} in the Control Feature Zones of a LightScribe DVD and a LightScribe CD, which have different distances between the disc surfaces and the Control Feature Zones, and sensitivities T_{DVD} and T_{CD} of the tracking actuator for the LightScribe DVD and the LightScribe CD and obtain the slope a from the focusing points F_{DVD} and F_{CD} and the sensitivities T_{DVD} and T_{CD}. This operation may be performed during a process of manufacturing the optical disc apparatus or while a user uses the optical disc apparatus to reflect a variation in the performance of the actuator with the lapse of time.

The controller 80 obtains the focusing point F₀ in the Control Feature Zone of a LightScribe disc inserted for label recording and the sensitivity T₀ of the tracking actuator and stores the focusing point F₀ and the sensitivity T₀ in the memory 90 in operation S110. The controller 80 may also calculate a tracking actuator control value V₀ required to move the object lens by a predetermine distance and store the control value V₀ in the memory 90. Operation S110 may be omitted when operation S100 is performed while the user uses the optical disc apparatus.

The controller 80 detects a focusing point F_{C} of the object lens, which is most suitable for each of areas, that is, each of a predetermined number of areas divided in the circumference direction and a predetermined number of areas divided in the radius direction, in order to perform a focusing servo operation in the feed forward method in operation S120. The controller 80 can check the current position in the circumference direction using an index mark and a spoke signal detected by the spoke detector 13. The controller 80 may move the optical pickup in the radius direction by a predetermined distance while recording labels using the detected focusing point and repeat the operation of detecting the focusing point with respect to each of the areas in the circumference direction at the moved point.

The controller 80 obtains a tracking actuator control value (driving voltage) V_{C} required to move the object lens in the inner or outer circumference direction by a predetermined distance with focusing offset being F_{C} using the equation described with reference to FIG. 8 in operation 5130.

The controller 80 controls the elements of the optical disc apparatus to record labels on the label plane through the focusing servo operation and the tracking servo operation in the feed forward method according to the values, obtained in operations S120 and S130, in operation S140.

While this document has been described in connection with what is presently considered to be practical exemplary embodiments, it is to be understood that this document is not limited to the disclosed embodiments, but, on the contrary, is intended to cover various modifications and equivalent arrangements included within the spirit and scope of the appended claims.

What is claimed is:

1. An optical disc recording method, comprising:
detecting a focusing point suitable for a position of an object lens in a circumference direction and/or a radius direction;
obtaining a tracking sensitivity corresponding to the detected focusing point based on information about a tracking sensitivity variation according to a focusing point variation; and
recording labels on a label plane using the detected focusing point and tracking sensitivity.

2. The optical disc recording method of claim 1, wherein the information is measured using at least two different types of discs one of which has a distance, between the surface of the disc and a pattern area, different from the distance of the other, the pattern area being required for a feed forward servo operation.

3. The optical disc recording method of claim 2, wherein the tracking sensitivity is detected using a saw-teeth pattern included in the pattern area.

4. The optical disc recording method of claim 1, wherein the information is measured during a process of manufacturing an optical disc apparatus or while a user uses the optical disc apparatus and stored in the optical disc apparatus.

5. The optical disc recording method of claim 1, wherein when a disc is divided into a predetermined number of sections in the radius direction, the focusing point is detected for each of the sections and applied to a focusing servo operation performed on the corresponding section.

6. The optical disc recording method of claim 5, wherein the position of the object lens in the radius direction is tracked based on a number of steps applied to a sled motor for moving an optical pickup including the object lens and a control value applied to a tracking actuator for moving the object lens in the inner and outer circumference directions.

7. The optical disc recording method of claim 5, wherein when a disc is divided into a predetermined number of areas in the circumference direction, the focusing point is detected for each of the areas and applied to a focusing servo operation performed on the corresponding area.

8. The optical disc recording method of claim 7, wherein the position in the circumference direction is checked by detecting spokes and an index mark included in the pattern area required for the feed forward servo operation.

9. The optical disc recording method of claim 1, wherein a control value obtained based on the tracking sensitivity is applied to a tracking actuator to move the object lens operating at the detected focusing point to the inner or outer circumference by a predetermined distance.

10. An optical disc apparatus comprising:
an optical pickup configured to read data from a data plane of an optical disc and record data on the data plane or a label plane of the optical disc;
a spindle motor configured to rotate the optical disc;
a sled motor configured to move the optical pickup to the inner or outer circumferences;
a detector configured to detect a position of the optical disc in a circumference direction; and
a controller configured to control at least one of the optical pickup, the spindle motor, the sled motor, and the detector to detect a focusing point suitable for a position of an object lens in the circumference direction and/or a radius direction, obtain a tracking sensitivity corresponding to the detected focusing point based on information about a tracking sensitivity variation according to a focusing point variation and record labels on the label plane using the detected focusing point and tracking sensitivity.

11. The optical disc apparatus of claim 10, wherein the information is measured using at least two different types of discs one of which has a distance, between the surface of the disc and a pattern area, different from the distance of the other, the pattern area being required for a feed forward servo operation.

12. The optical disc apparatus of claim 11, wherein the tracking sensitivity is detected using a saw-teeth pattern included in the pattern area.

13. The optical disc apparatus of claim 10, further comprising a memory, wherein the information is measured during a process of manufacturing an optical disc apparatus or while a user uses the optical disc apparatus and stored in the memory.

14. The optical disc apparatus of claim 10, wherein the controller is configured to divide the disc into a predetermined number of sections in the radius direction, detect the focusing point for each of the sections and apply the detected focusing point a focusing servo operation performed on the corresponding section.

15. The optical disc apparatus of claim 14, wherein the controller is configured to track the position of the object lens in the radius direction based on a number of steps applied to the sled motor and a control value applied to a tracking actuator for moving the object lens in the inner and outer circumference directions.

16. The optical disc apparatus of claim 10, wherein the controller is configured to divide the disc into a predetermined number of areas in the circumference direction, detect the focusing point for each of the areas and apply the detected focusing point to a focusing servo operation performed on the corresponding area.

17. The optical disc apparatus of claim 16, wherein the controller is configured to check the position in the circumference direction by detecting spokes and an index mark included in the pattern area required for the feed forward servo operation.

18. The optical disc apparatus of claim 10, wherein the controller is configured to apply a control value obtained based on the tracking sensitivity to a tracking actuator to move the object lens operating at the detected focusing point to the inner or outer circumference by a predetermined distance.
